(19) United States
(12) Patent Application Publication
(10) Pub. No.: US 2023/0289769 A1
(43) Pub. Date: Sep. 14, 2023

(54) SECURE TRANSACTION NETWORKS

(71) Applicant: Shtar LLC, Brooklyn, NY (US)

(72) Inventor: Moshe B. Teitelbaum, Brooklyn, NY (US)

(21) Appl. No.: 17/967,874

(22) Filed: Oct. 17, 2022

Related U.S. Application Data
(60) Provisional application No. 63/256,307, filed on Oct. 15, 2021.

(51) Int. Cl. G06Q 20/32; G06Q 10/087; G06Q 20/38; G06Q 20/40

(52) U.S. Cl. CPC G06Q 20/325; G06Q 10/087; G06Q 20/389; G06Q 20/401

(57) ABSTRACT

Systems and methods are disclosed for secure transaction networks. In one implementation, a first transaction record, including first parameter(s), generated by a first entity, and directed to a second entity, is received. The first transaction record is processed to determine whether at least one of the first parameter(s) are consistent with parameter(s) utilized by the second entity. Based on the processing, a second transaction record, including second parameter(s) that correspond to the first parameter(s), is generated. Operation(s) are initiated with respect to the second transaction record.

### CROSS-REFERENCE TO RELATED APPLICATION

This application is related to and claims the benefit of priority to U.S. Patent Application No. 63/256,307, filed Oct. 15, 2021, which is incorporated herein by reference in its entirety.

### TECHNICAL FIELD

Aspects and implementations of the present disclosure relate to data processing and, more specifically, but without limitation, to secure transaction networks.

### BACKGROUND

Existing transaction frameworks can enable users to initiate transactions between one account and another.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates aspects of the features, functions, and operations of an example system, in accordance with an example embodiment.

FIG. 3 illustrates further aspects of the features, functions, and operations of an example system, in accordance with an example embodiment.

FIG. 4 illustrates further aspects of the features, functions, and operations of an example system, in accordance with an example embodiment.

FIG. 5 illustrates further aspects of the features, functions, and operations of an example system, in accordance with an example embodiment.

FIG. 6 illustrates further aspects of the features, functions, and operations of an example system, in accordance with an example embodiment.

FIG. 7 illustrates further aspects of the features, functions, and operations of an example system, in accordance with an example embodiment.

FIG. 8 illustrates further aspects of the features, functions, and operations of an example system, in accordance with an example embodiment.

FIG. 9 illustrates further aspects of the features, functions, and operations of an example system, in accordance with an example embodiment.

FIG. 10 is a flow chart illustrating aspects of a method for secure transaction networks, in accordance with an example embodiment.

FIG. 11 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to secure transaction networks.

Numerous systems touch various aspects of routine commercial activity (e.g., accounting systems, banking systems, inventory management systems, shipping and delivery management systems, shipping companies, etc.). While some systems can be configured to interface with one another in limited ways, none fully encompass the entirety of commercial activity. Additionally, while an organization or entity may be able to associate or integrate aspects of their internal systems (e.g., internal accounting and banking systems), such integrations do not extend outside the organization.

Accordingly, described herein in various implementations are technologies that enable secure transaction networks and other related operations. Using the described technologies, numerous discrete systems and computing environments—both inside and outside a given entity—can be configured to interact with one another in a manner that enhances the consistency and interoperability of the data exchanged. In some implementations, the described technologies can enable individual systems to utilize independent nomenclature, naming conventions, and other parameters internally, while developing and implementing associations between such respective parameters. In doing so, discrepancies between transaction records or other information stored across multiple systems and environments can be reduced or eliminated. Additionally, numerous additional features and functionalities can be realized, including audit tracking and transaction verification. These and other features can enable multiple discrete systems to operate both independently and coherently/consistency, such that an end-to-end transaction network can be realized. Within the described transaction network, numerous aspects of (previously unrelated) commercial activity can be associated with one another in a manner that preserves convenience and reliability for existing users while also providing enhanced functionality, security, and efficiency, as well as improved performance, as described herein.

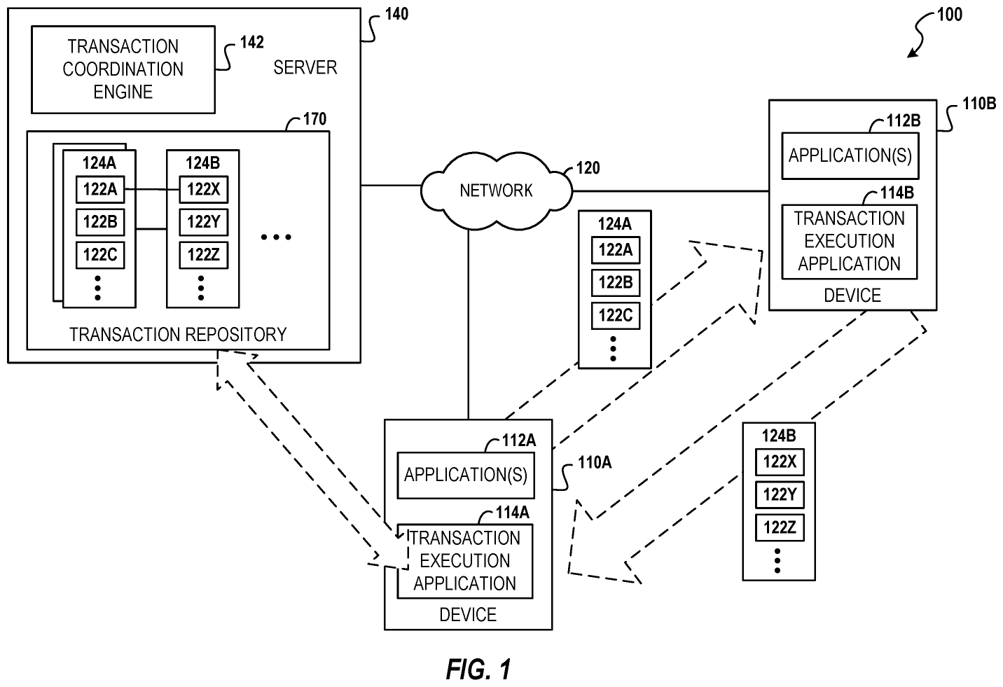

FIG. 1 illustrates an example system 100, in accordance with some implementations. As shown, the system 100 includes components such as device 110A and device 110B (collectively, devices 110). Each of the referenced devices 110 can be, for example, a laptop computer, a desktop computer, a smartphone, a mobile phone, a terminal, a tablet computer, a smart watch, a wearable device, a connected device, a speaker device, a server, and the like. Human users can interact with respective device(s) 110. For example, a user can provide various inputs (e.g., via an input device/interface such as a keyboard, mouse, touchscreen, microphone, etc.) to device(s) 110A. Device(s) 110 can also display, project, and/or otherwise provide content to the user (e.g., via output components such as a screen, speaker, etc.).

As shown in FIG. 1, device(s) 110 can include one or more application(s) 112. Such applications can be programs, modules, or other executable instructions that configure/enable the device to interact with, provide content to, and/or otherwise perform operations on behalf of a user. Examples of such applications include but are not limited to internet browsers, mobile apps, ecommerce applications, social media applications, personal assistant applications, games, etc.

By way of further illustration, application(s) 112 can include mobile apps that enable users to initiate various transactions and/or other operations with third party services, such as banking services, food delivery services, ride sharing services, ecommerce services, websites, platforms, etc. By way of yet further illustration, application(s) 112 can include accounting applications, such as those that enable users to track incoming and outgoing payments, transactions, invoices, etc. Other examples of such applications can include those utilized in connection with an enterprise resource planning (ERP) system (such as those that enable users to plan, forecast, mange or track digital/physical inventory, goods, or other resources) or a point of sale (POS) system (such as those that enable users to perform retail transactions and mange retail inventory and resources).

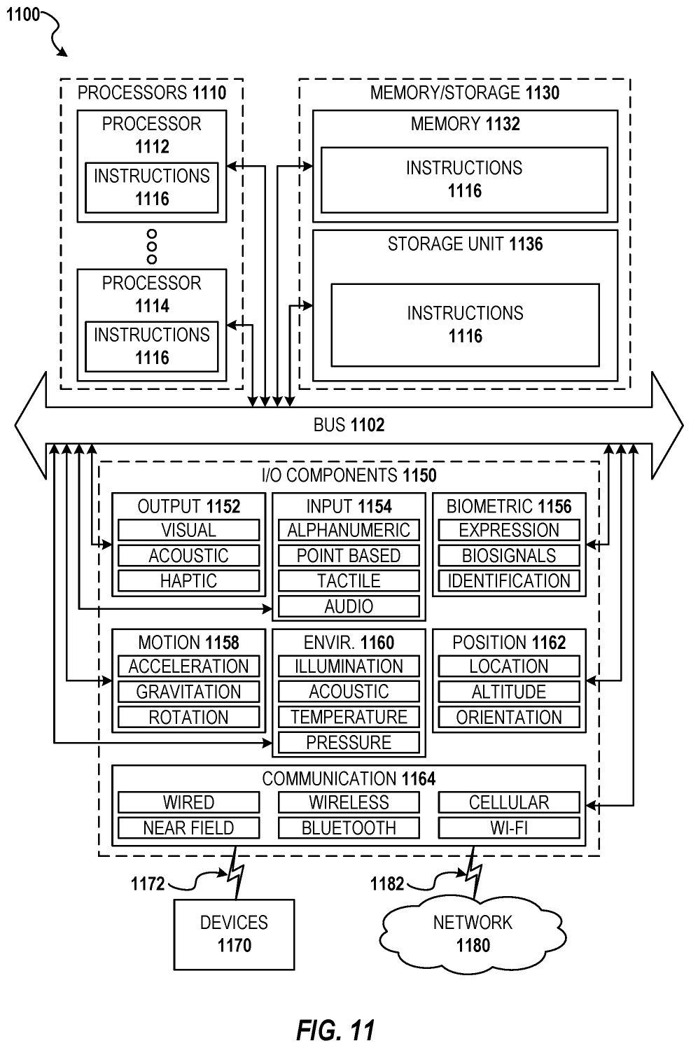

Application(s) 112 can be stored in memory of device 110 (e.g., memory 1130 as depicted in FIG. 11 and described below). One or more processor(s) of device 110 (e.g., processors 1110 as depicted in FIG. 11 and described below) can execute such application(s). In doing so, device 110 can be configured to perform various operations, present content to a user, etc.

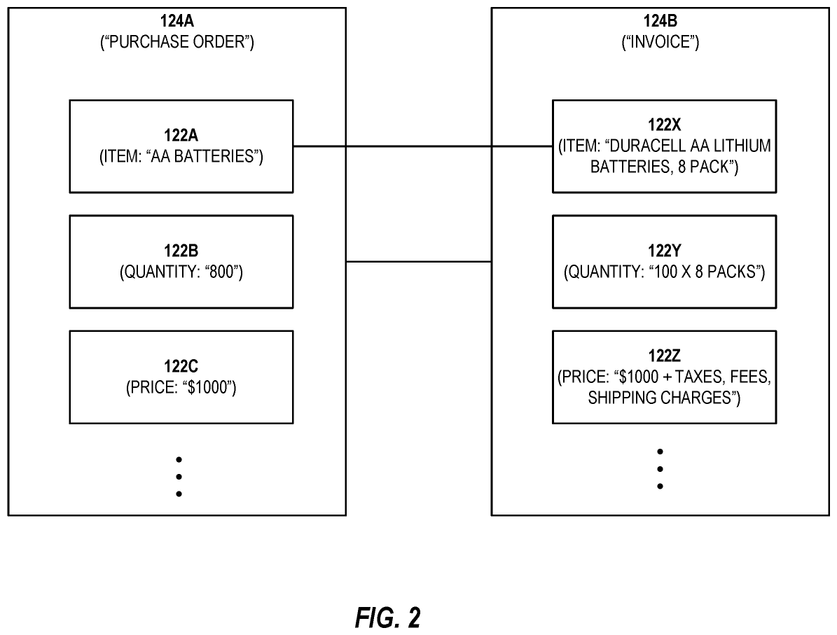

In certain implementations, device 110 can also include transaction execution application 114. Transaction execution application 114 can include, for example, programs, modules, or other executable instructions that configure/enable the device to initiate/execute transactions in relation to other device(s), machines, systems, services, etc., such as device(s) 110, server 140, services 150, etc. Additionally, in certain implementations transaction execution application 114 can be configured to generate and/or modify or adjust aspects of various transaction records, and/or perform other operations, as described herein, e.g., with respect to FIGS. 2-10.

It should be noted that while application(s) 112 and 114 are depicted and/or described as operating on a device 110, this is only for the sake of clarity. However, in other implementations such elements can also be implemented on other devices/machines. For example, in lieu of executing locally at device 110, aspects of application(s) 112 can be implemented remotely (e.g., on a server device or within a cloud service or framework).

As also shown in FIG. 1, device 110A can connect to and/or otherwise communicate with other device(s) 110B, server 140, and other machines, devices, systems, services, etc. via network 120. Network 120 can include one or more networks such as the Internet, a wide area network (WAN), a local area network (LAN), a virtual private network (VPN), an intranet, and the like.

Server 140 can be, for example, a server computer, computing device, storage service (e.g., a ‘cloud’ service), etc. that enables operations including the coordination and execution of transactions between parties, as described herein. In certain implementations, server 140 can include transaction execution engine 142.

Transaction execution engine 142 can be an application, module, instructions, etc., that configures/enables the server to perform various operations described herein. In certain implementations, transaction execution engine 142 can securely and verifiably coordinate transactions and other operations between parties and institutions, as described herein. These and other described features, as implemented with respect to server 140 and/or one or more particular machine(s), can improve the functioning of such machine(s) and/or otherwise enhance numerous technologies including enabling and enhancing the security, execution, and management of various transactions, as described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

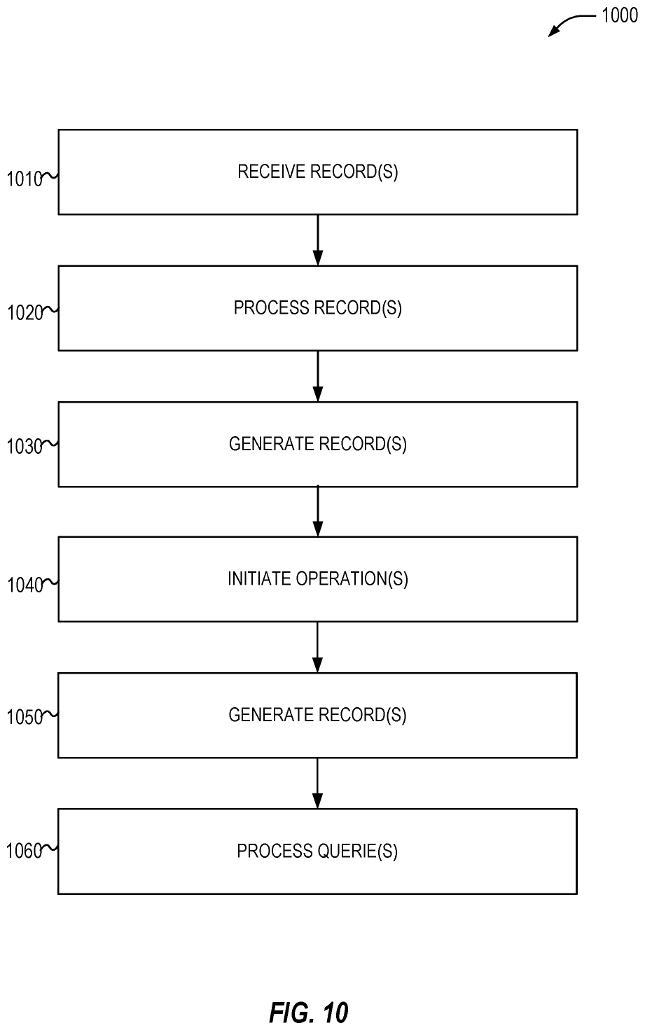

In certain implementations, various aspects of the described technologies include methods performed by processing logic that can comprise hardware (circuitry, dedicated logic, etc.), software (such as is run on a computing device such as those described herein), or a combination of both. For example, FIG. 10 is a flow chart illustrating a method 1000, according to an example embodiment, for secure transaction networks. The method is performed by processing logic that can comprise hardware (circuitry, dedicated logic, etc.), software (such as is run on a computing device such as those described herein), or a combination of both. In one implementation, the method 1000 is performed by one or more elements depicted and/or described in relation to FIG. 1 (including but not limited to server 140, one or more applications or modules executing thereon, and/or device(s) 110), while in some other implementations, the one or more blocks of FIG. 10 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

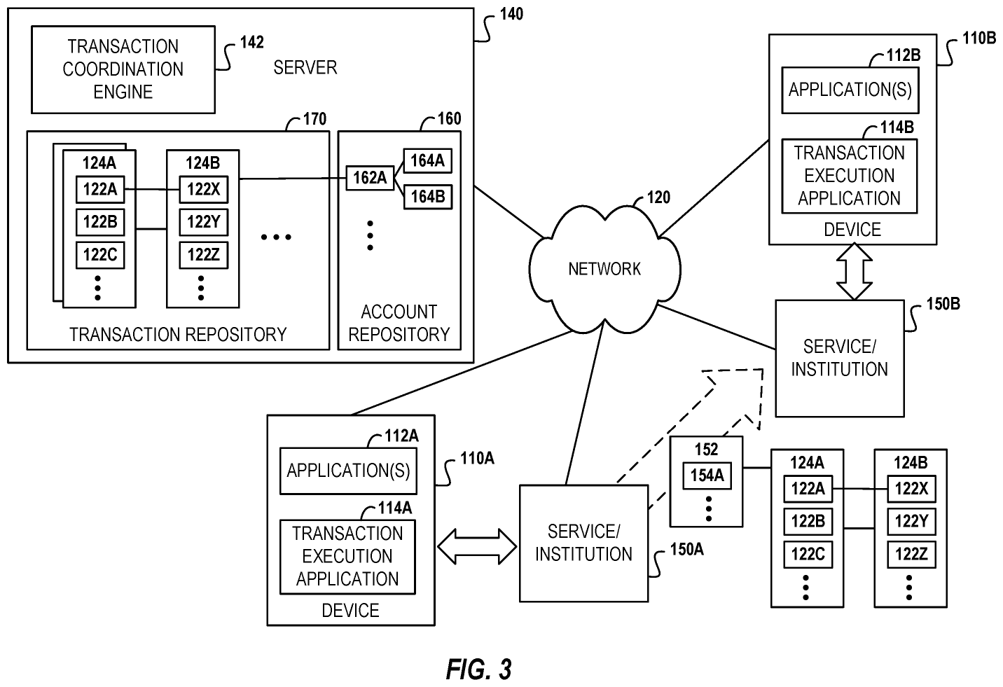

In certain implementations, transaction execution engine 142 can generate and maintain repositories, such as account repository 160 (e.g., as shown in FIG. 3 and described herein) and transaction repository 170. Such repositories can be further utilized to enable the association of multiple transaction records and provide various other technical advantages and improvements, as described herein.

Transaction repository 170 can be a storage resource such as an object-oriented database, a relational database, a decentralized or distributed ledger (e.g., blockchain), etc. In certain implementations, transaction repository 170 can maintain various transaction records 124A, 124B, etc. Such transaction records can be data structures or other such content or information that include or reflect aspects of a transaction (e.g., a purchase/sale of goods between two entities). As shown in FIGS. 1-2 and described herein, such transaction records can further include information such as the item being purchased, the quantity, amount, costs, etc. (e.g., as reflected in a purchase order, invoice, etc.). For example, an entity seeking to purchase a product can transmit a purchase order identifying the item, quantity, price, etc., in response to which a selling entity can transmit an invoice containing related (though, under some circumstances, different or updated) information from that contained or reflected in an initial purchase order (or at an earlier stage of the transaction). Additionally, in certain implementations transaction repository 170 can include or incorporate a ledger (e.g., of various transactions or other operations) between various users, accounts, entities, etc. (which can further include/incorporate data identifying associated entities, amount(s), timestamp(s), etc.).

At operation 1010, a first transaction record is received. In certain implementations, such a first transaction record can include one or more first parameters, such as are described herein. Additionally, in certain implementations such a first transaction record can be generated by a first entity and/or directed to a second entity.

By way of further illustration, in one example scenario, device 110A can correspond to a user or entity seeking to initiate a purchase of goods from another user or entity (110B). In certain implementations, device 110A can generate and/or transmit a first transaction record 124A. For example, application(s) 112A (e.g., an accounting application) can generate a first transaction record 124A (such as a purchase order). Such a first transaction record 124A can include various parameters or values 122A-122C. Such parameters can reflect, for example, the item(s) the purchaser seeks to purchase, the quantity desired, and the price the purchaser wishes to pay. As shown in FIG. 1, in certain implementations device 110A (e.g., a purchaser) can send or transmit the generated first transaction record 124A to device 110B (e.g., the entity from which the purchaser wishes to purchase the item(s)).

While many of the examples described herein are illustrated with respect to multiple machines 110, 140, 150, etc., this is simply for the sake of clarity and brevity. However, it should be understood that the described technologies can also be implemented (in any number of configurations) with respect to a single computing device/service.

FIG. 2 depicts further aspects of such a first transaction record 124A. As shown in FIG. 2, first transaction record 124A (e.g., a purchase order generated by device 110A) can include an identification of an item the purchaser wishes to acquire (“AA BATTERIES”), a quantity the user wishes to acquire (“800”) a price the user wishes to pay “$1000”) and other parameters (e.g., delivery date, delivery location, etc.).

As further shown in FIG. 1, first transaction record 124A (e.g., the referenced purchase order) can be transmitted by device 110A to device 110B (e.g., a device corresponding to the vendor from whom the goods are being purchased). In certain implementations, transaction execution application 114A (as executing on device 110A) can coordinate aspects of the transmission of such a transaction record. In one example implementation, transaction execution application 114A can be a plug-in (or freestanding application) that operates in conjunction with application(s) 112A (e.g., an accounting application).

At operation 1020, the first transaction record (e.g., as received at 1010) is processed. For example, as described in further detail herein, transaction execution application 114A can process data originating from and/or directed to application(s) 112A. In doing so, transaction execution application 114A can, for example, ensure data originating from application(s) 112A is consistent with the nomenclature, naming conventions, formatting, and/or other parameters that may be dictated by the recipient(s) of such data. By way of further example, transaction execution application 114A can, for example, ensure data originating from external source(s) is consistent with nomenclature, naming conventions, formatting, and/or other parameters that may be dictated by application(s) 112A.

Additionally, in certain implementations transaction execution application 114A can operate in conjunction with transaction execution engine 142 and/or other elements or components of server 140. As described herein, server 140 and transaction execution engine 142 can operate to create and implement a network within which various aspects of transactions can be automated, adjusted, or enhanced (e.g., to ensure consistency, security, and authenticity across multiple parties and systems). For example, transaction execution application 114A can also provide first transaction record 124A (e.g., the referenced purchase order) to server 140. Such a first transaction record 124A can be further stored in transaction repository 170, as shown in FIG. 1.

At operation 1030, a second transaction record is generated (e.g., based on the processing at 1020). For example, in the scenario described above (and/or as depicted in FIG. 1), upon receiving first transaction record 124A originating from device 110A (e.g., a purchaser), device 110B (e.g., the vendor of the item the purchaser wishes to purchase) can generate and transmit second transaction record 124B (e.g., an invoice for the referenced transaction).

FIG. 2 depicts further aspects of such a second transaction record 124B. As shown in FIG. 2, second transaction record 124B (e.g., an invoice generated by device 110B) can include an identification of an item being sold (“DURACELL AA LITHIUM BATTERIES . . . ”), a quantity the being sold (“100×8 PACKS”) a price being charged “$1000+TAXES, FEES . . . ”) and other parameters (e.g., delivery date, delivery location, etc.).

As further shown in FIG. 1, second transaction record 124B (e.g., the referenced invoice) can be transmitted by device 110B to device 110A (e.g., a device corresponding to the purchaser who ordered the goods being purchased). In certain implementations, transaction execution application 114B (as executing on device 110B) can coordinate aspects of the transmission of such a transaction record. In one example implementation, transaction execution application 114B can process data originating from and/or directed to application(s) 112, e.g., to ensure data originating from application(s) 112B is consistent with formatting, naming conventions, and/or other parameters that may be dictated by the recipient(s) of such data. By way of further example, transaction execution application 114B can, for example, ensure data originating from external source(s) is consistent with formatting, naming conventions, and/or other parameters that may be dictated by application(s) 112B.

Additionally, in certain implementations transaction execution application 114B can operate in conjunction with transaction execution engine 142 and/or other elements or components of server 140. For example, transaction execution application 114B can also provide second transaction record 124B (e.g., the referenced invoice) to server 140. Such a second transaction record 124B can be further stored in transaction repository 170, as shown in FIG. 1.

As noted, in certain implementations the referenced second transaction record is generated to include parameter(s) that correspond to those from the first transaction record. For example, FIG. 2 depicts aspects of the described first transaction record 124A (e.g., a purchase order generated by device 110A and transmitted to device 110B) and second transaction record 124B (e.g., an invoice generated by device 110B and transmitted to device 110A), e.g., as stored within transaction repository 170. As shown in FIG. 2, various parameters or elements contained within one transaction record may correspond or otherwise relate to those contained in another.

For example, as shown in FIG. 2, first transaction record 124A can include parameter 122A (“AA BATTERIES”), which identifies the product the purchaser wishes to order (e.g., via device 110A). Second transaction record 124B can include a corresponding parameter 122X (“DURACELL AA LITHIUM BATTERIES . . . ”), which identifies the product being sold (e.g., as maintained internally by device 110B). While related, different organizations may identify or refer to the same product in different ways. As a result, errors or discrepancies can arise in numerous scenarios, such as when a customer sends a purchase order using one identifier (e.g., “AA BATTERIES”) while a vendor's corresponding invoice utilizes another identifier (e.g., “(“DURACELL AA LITHIUM BATTERIES . . . ”).

Accordingly, in certain implementations the described technologies can be configured to generate and maintain multiple associations between corresponding, related, etc. elements and/or their respective underlying transaction record(s). For example, as shown in FIG. 2, transaction coordination engine 142 can generate an association or link between parameter, value, etc. 122A (that is, a parameter included in first transaction record 124A, e.g., “AA BATTERIES”) and parameter, value, etc. 122X (that is, a parameter included in second transaction record 124B, e.g., “DURACELL AA LITHIUM BATTERIES . . . ”).

In certain implementations, such an association or link can be identified and/or generated based on a determination that first transaction record 124A and second transaction record 124B are records that reflect aspects of the same transaction (e.g., the purchase/sale of the same goods). In other implementations, such an association or link can be identified and/or generated based on a determination that aspects of the respective parameters (e.g., parameter, value, etc. 122A within first transaction record 124A and parameter, value, etc. 122X within second transaction record 124B) contain the same or related keywords or identifying information (e.g., “AA” and “BATTERIES”), and/or other semantic similarities.

In other implementations, the referenced association(s), link(s), etc., (e.g., between other transaction records) can be utilized to facilitate transactions between multiple parties, entities, etc. For example, as described above (e.g., with respect to FIG. 2), a transaction record generated by one device (e.g., transaction record 124A, as generated by device 110A, which can be associated with an entity attempting to make a purchase) can include parameter(s) 122 that correspond to other parameters used by other entities. As also described herein, it can be advantageous to determine correspondences between such parameters, records, etc., and to further create associations, links, etc., between such parameters, records, etc. Doing so can, for example, facilitate the automated processing of various operations, transactions, etc., as described herein.

In certain implementations, the referenced determinations can be computed based on association(s), link(s), etc., between other transaction records (e.g., transaction records not between the parties currently at issue). By way of illustration, one device/entity (e.g., a company associated with device 110A) can transmit a transaction record 124A (e.g., a purchase order) to a second entity (e.g., associated with device 110B). In such a scenario, though the first entity (110A) may not have performed previous operations, transactions, etc., with the second entity (110B), transaction repository 170 can maintain records and other information relating to other transactions between the referenced second entity (110B) and other entities (e.g., 110C, 110D, etc.). Such transaction records can be further associated with other transaction records, such as those corresponding to transactions with other entities.

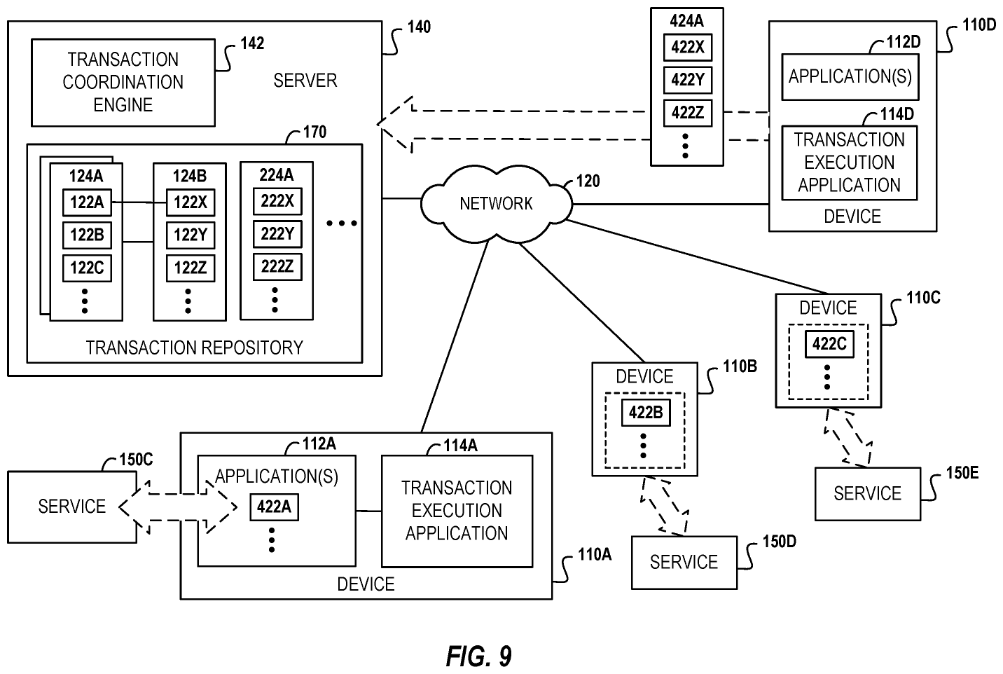

By way of further illustration, in another example scenario (such as one comparable to that depicted in FIG. 9), an entity corresponding to device (110D) can initiate operation(s), transaction(s), etc., e.g., with respect to other entitie(s) (e.g., an entity corresponding to device 110A). Such a transaction record 424A (e.g., a purchase order) can incorporate multiple parameters 422 (e.g., parameter 422X, which can identify or describe an item for purchase, such as “AA BATTERIES”). The described technologies can process prior transaction records and other information (such as those maintained in transaction repository 170) to determine, for example, whether the same entity/device (110D) utilized the same/comparable parameter (422X, e.g., “AA BATTERIES”) with respect to an operation, transaction, etc. associated with other entitie(s). For example, transaction records, associations, and other information stored in repository 170 can reflect that the entity corresponding to device 110D utilized the same/comparable parameter (422X, e.g., “AA BATTERIES”) with respect to operation(s), transaction(s), etc., associated with another entity (e.g., device 110B). Such identified transaction records, etc., can further reflect association(s) between the referenced parameter utilized by to device 110D (422X, e.g., “AA BATTERIES”) and parameters utilized by such other entities (e.g., “DURACELL AA LITHIUM BATTERIES . . . ”). Based on such associations (e.g., between the referenced parameter 422X, e.g., “AA BATTERIES” and parameter(s) originating from transaction records associated with device 110B, e.g., “DURACELL AA LITHIUM BATTERIES . . . ”), the described technologies can further determine that in operation(s), transaction(s), etc. between device 110D and other entitie(s)/device(s), the referenced parameter (e.g., 422X, such as “AA BATTERIES”) is likely to correspond to parameter(s) determined to be the same/comparable to those associated with the referenced parameter (e.g., “DURACELL AA LITHIUM BATTERIES . . . ”). In doing so, the described technologies can, for example, leverage association(s) generated in operations or transactions between devices 110D and 110B to automate the processing of transactions between devices 110D and 110A. Doing so can be advantageous in numerous scenarios, including in an initial operation/instance, at which point device 110D may not have previously transacted with device 110A (and thus comparable prior transaction records may not exist between the two devices/entities). In such a scenario, the described technologies can leverage associations generated with respect to operations, transactions, etc., between other entities, to determine (e.g., at a first instance) corresponding associations between parameters used in the respective system(s) of devices 110D and 110A. Based on such determinations (as computed, for example, based on transaction records corresponding to devices 110D and 110B) the described technologies can further determine, at the first instance(s), associations between parameters included in transaction records between devices 110D and 110A, as described herein.

Moreover, in certain implementations, the referenced transaction repository can reflect associations between parameters contained within transaction records of transactions between other entities. Based on such associations, the described technologies can determine that the same/comparable parameter(s) (e.g., as referenced in one set of transaction records) refers to the same item (e.g., in another operation/transaction, including between different devices, entities, etc.).

Additionally, in certain implementations associations between parameters within transactions between other entities (e.g., as stored in repository 170) can also be leveraged in identifying associations within other operations, transactions, etc. For example, transaction records corresponding to a transaction between devices 110B and 110C can reflect, for example, that one parameter (e.g., “AA BATTERIES”) included within one transaction record (e.g., originating from device 110B) corresponds to another parameter (e.g., “DURACELL AA LITHIUM BATTERIES . . . ”) included within another transaction record (e.g., originating from device 110C). Based on such association(s), the described technologies can further identify or otherwise determine that the same/comparable parameter (e.g., “AA BATTERIES”) included within a transaction record originating from device 110A corresponds to a parameter (e.g., “DURACELL AA LITHIUM BATTERIES . . . ”) included within another transaction record (e.g., originating from device 110D). In doing so, the described technologies can further determine, at the first instance(s), associations between parameters included in transaction records between devices 110A and 110D, as described herein.

Moreover, in certain implementations the described technologies can further process the referenced transaction records and associations between them and/or their underlying parameters to further identify or determine associations in other scenarios. For example, records, associations, etc. stored in repository 170 can be processed to identify naming conventions, nomenclature, correspondences, etc. between such conventions, etc., across different transaction records. For example, certain parameters can reflect quantities (e.g., “Eight” or “8”), abbreviations (e.g., “International” or “Intl”), and other comparable elements in different ways. Such associations can be further determined using natural language processing and/or other such techniques. Based on such determinations, the described technologies can further compute associations between parameters contained within various transaction records, as described herein.

It should be understood that such techniques are provided by way of example and the referenced association(s) between parameters, values, etc. can be generated in any number of other ways.

Additionally, in certain implementations association(s), link(s), etc., between respective transaction records can be generated and stored together with the referenced record(s). For example, as shown in FIG. 2, an association, link, etc. between first transaction record 124A and second transaction record 124B can be generated. Such an association can reflect that while such transaction records originate from different sources (e.g., devices 110A and 110B, respectively), the respective records reflect aspects of the same (or related) underlying transaction(s). Such an association, link, etc. (e.g., between first transaction record 124A and second transaction record 124B) can further enable the identification that various aspects of one transaction record correspond to or elements contained within another record. Doing so can enable numerous discrete systems to utilize their own independent nomenclature, lexicon, etc., while ensuring consistency and minimizing redundancy and errors across such systems. As shown in FIG. 1, the referenced association(s) between parameters and transaction records can be stored with such records, e.g., at transaction repository 170.

At operation 1040, one or more operations are initiated (e.g., based on and/or with respect to the transaction record generated at 1030).

By way of further illustration, FIG. 2 further depicts how aspects of various transaction records may change over the course of a transaction. For example, as shown in FIG. 2, while an initial purchase order (124A) can reflect a “base” price the customer wishes to pay, a subsequent invoice may incorporate additional charges (e.g., taxes, fees, etc.) (122Z). Other aspects of a transaction can also change at various stages (e.g., the quantity initially ordered vs. quantity fulfilled).

FIG. 3 depicts further aspects of the described transaction. As shown in FIG. 3, at a subsequent stage of the referenced transaction (e.g., upon receipt of the referenced invoice, upon delivery of the referenced goods, etc.), the purchaser can initiate an operation such as a secure transaction (e.g., a payment) directed to the vendor. In certain implementations, such a transaction can be coordinated between multiple banking services or institutions (e.g., institution 150A, corresponding to a bank associated with device 110A, and institution 150B, corresponding to a bank associated with device 110B).

For example, application(s) 112A executing on device 110A (e.g., an accounting application used by the purchaser of the goods) can transmit instructions to institution 150A (e.g., a bank or payment service associated with the purchaser) to initiate payment for the purchase to the vendor. In certain implementations, transaction execution application 114A (e.g., a plugin application executing on device 110A in conjunction with application(s) 112A) can coordinate the generating of a transaction record 152 corresponding to such a payment that further reflects aspects of the underlying transaction. Doing so can be advantageous to create an audit trail and ensure that a payment between two parties can be identified to correspond to a particular transaction.

As noted, service/institution 150A and service/institution 150B (collectively, services/institutions 150) can be for example, financial institutions, ecommerce websites, credit/debit card platforms, or other such third-party services with respect to which entities or individuals may maintain accounts. Such accounts can be associated with account numbers, routing numbers, credit/debit card numbers, and/or other such account identifiers which can be used, for example, to enable one entity to initiate a payment or other such transaction or operation to another entity. In certain implementations, such transactions can be executed via various payment networks (e.g., ACH, RTP, debit/credit card, wire, etc.) that enable transactions between the respective accounts each user maintains with the respective institution(s).

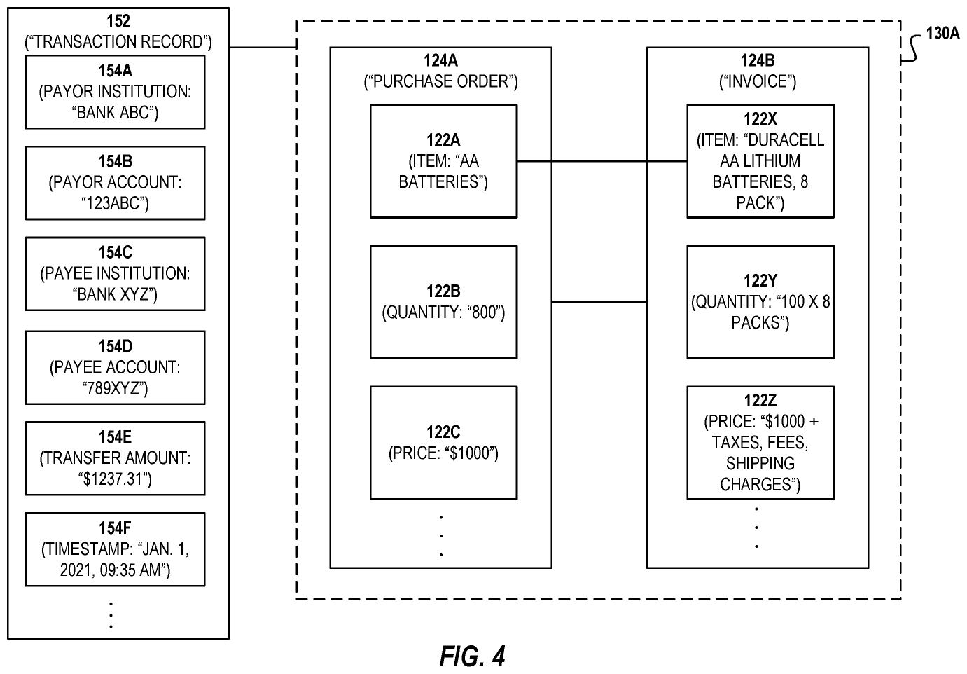

Further aspects of such a transaction record 152 and the referenced operation(s) (e.g., validation operation(s)) are shown in FIG. 4. As shown in FIG. 4, transaction record 152 (which corresponds to a payment from a purchaser to a vendor) can include parameters 154 which can identify the institution and account from which the payment originates (e.g., 154A, 154B), the institution and account to which the payment is directed (e.g., 154C, 154D), the payment amount (154E), a timestamp (154F), and other information corresponding to a financial transaction.

As also shown in FIG. 4, a transaction log 130 can be further associated with transaction record 152. Such a transaction log can incorporate underlying records, documentation, or other information that reflect aspects of the referenced transaction. For example, transaction log 130 can include first transaction record 124A (e.g., a purchase order that initiated a transaction), second transaction record 124B (e.g., a corresponding purchase order), and the association(s) between such transaction record(s) (as described with respect to FIGS. 1-2). Associating transaction log 130 to transaction record 152 can create an audit trail and provides further context to the referenced financial transaction, and enables validation, confirmation, and authentication of the underlying transaction (in lieu of a transfer of funds between two accounts with little additional context or information). The referenced transaction log(s) 130 and transaction record(s) 152 can also be stored, e.g., at repository 170.

Additionally, as shown in FIG. 3, in certain implementations server 140 can further maintain account repository 160. Account repository 160 can be a storage resource such as an object-oriented database, a relational database, a decentralized or distributed ledger (e.g., blockchain), etc. In certain implementations, account repository 160 can be a database that maintains identifiers for various individuals/entities 162 (e.g., usernames, email addresses, telephone numbers, and/or other custom and/or user-defined fields, etc., each of which may be associated with a user or entity), each of which can be further associated with multiple underlying account identifiers 164 (e.g., an account number, routing number, credit/debit card number, etc.). For example, identifier 162A can correspond to purchasing entity 110A and can further be associated with account 164A (e.g., a checking account) and account 164B (e.g., a credit card account). Using identifier repository 160, server 140 can utilize multiple account identifiers to execute a transaction. The system can then coordinate the referenced transaction between the respective institutions 150 using the determined account identifiers.

For example, in coordinating the described operations, transaction execution application 114A and transaction coordination engine 142 can select an account 164 with respect to which a given transaction is to be executed. In certain implementations, such an account can be selected based on various user-defined conditions, rules, etc. For example, transactions above a defined cost threshold can be processed with respect to one account, while others above the threshold can be processed via another account. It should be understood that such techniques are provided by way of example and the referenced conditions, rules, etc. can be implemented in any number of other ways.

By way of yet further example, in certain implementations the referenced rules, conditions, etc. can include but are not limited to: entity restriction(s) (e.g., which define the manner with respect to which outgoing and/or incoming transactions directed to a certain user, entity, etc. are to be processed), transaction amount restriction(s) (e.g., which define the manner with respect to which outgoing and/or incoming transactions of a certain amount are to be processed), transaction frequency restriction(s) (e.g., which define the manner with respect to which outgoing and/or incoming transactions occurring at a certain frequency are to be processed), and geographic restriction(s) (e.g., which define the manner with respect to which outgoing and/or incoming transactions initiated at a certain distance from a defined location such as the home of a user are to be processed, which may be determined based on to inputs or determinations originating from various sensors and/or other devices, such as inputs originating from a GPS receiver of one or more devices associated with a user).

In these and other implementations and scenarios, the described technologies can further configure and/or otherwise interact with various sensor(s) to enhance and/or improve the functioning of one or more machine(s). Doing so enhances the security, execution, and management of various transactions, as described herein. In contrast, existing technologies are incapable of enabling performance of the described operations in a manner that ensures their efficient execution and management, while also maintaining the security and integrity of such transactions, as described herein.

Moreover, in certain implementations the referenced rules, conditions, etc. can further include or account for or more other transactions (e.g., as stored in transaction repository 170). For example, as described herein, in certain implementations the transaction history of an entity that initiated a transaction can be accounted for in determining the manner in which such a transaction is to be processed (e.g., to determine the underlying identifiers with respect to which outgoing and/or incoming transactions are to be processed under certain circumstances/scenarios). For example, in scenarios in which such transaction historie(s) reflect that transactions bearing certain characteristics are processed with respect to particular account identifier(s), subsequent transactions, etc., determined to be comparable can be processed accordingly.

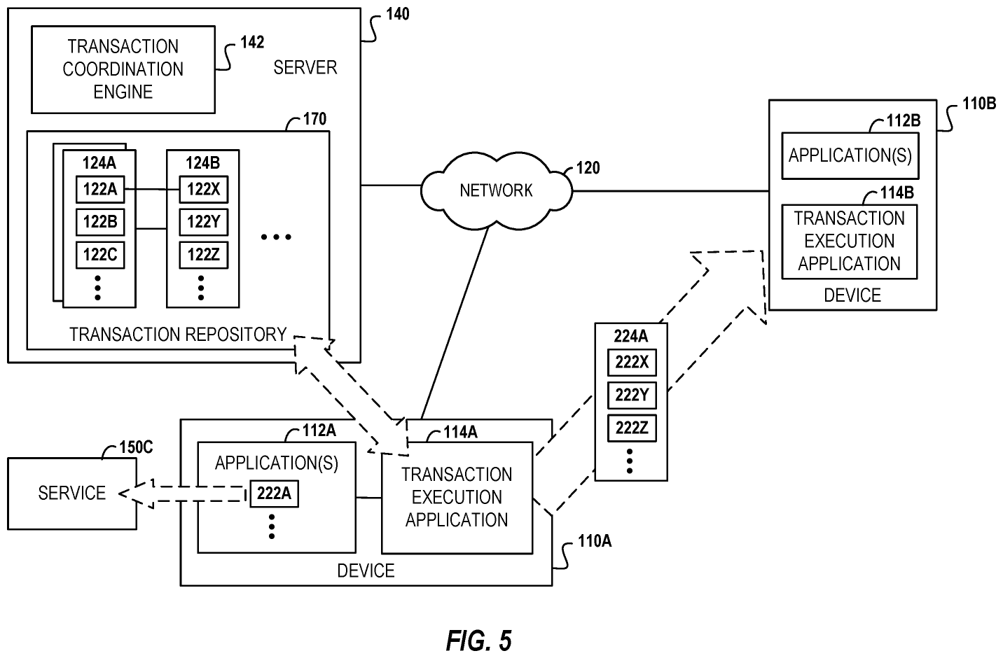

FIG. 5 depicts an example scenario in which device 110A initiates another transaction with device 110B (e.g., subsequent to the transaction depicted in FIGS. 1-4 and described herein). As shown in FIG. 5, transaction execution application 114A can execute in conjunction with application(s) 112A (e.g., an accounting application) to generate transaction record 224A (e.g., a purchase order). As also shown in FIG. 5, transaction execution application 114A can generate such a transaction record 224A based on previously stored transaction records 124A, 124B, which can reflect, for example, prior transaction(s) between purchaser 110A and vendor 110B.

For example, as described with respect to FIGS. 1-2, device 110A (e.g., a purchaser) may refer to an item using one identifier, naming convention, nomenclature, etc. (e.g., “AA BATTERIES”) while device 110B may refer to the same item using another identifier, naming convention, nomenclature, etc. (e.g., “DURACELL AA LITHIUM BATTERIES . . . ”). The discrepancy between this (and other) aspects of the independent operations of devices 110A and 110B, respectively, can cause errors or other inefficiencies, as described herein. For example, upon receipt of a purchase order for “AA BATTERIES,” the vendor may need to manually review the request to ascertain the appropriate identifier (as used within a system maintained by the vendor) being referenced.

By implementing the described technologies, prior transaction(s) and other information (e.g., as stored in transaction repository 170) can be utilized to preemptively identify the identifier (as used within the vendor's systems) which the purchaser is referencing. Upon identifying or otherwise determining such an identifier, transaction execution application 114A can insert, inject, or otherwise modify or adjust a transaction record transmitted by the purchaser to reflect the identifier used by the vendor. In doing so, the transaction record provided to/received by the vendor can already include identifiers or other information that is consistent with the naming conventions, nomenclature, etc., as used by the vendor (in lieu of requiring manual review by the vendor to interpret the contents of the purchase order).

At operation 1050, a third transaction record is generated. In certain implementations, such a third transaction record can be generated based on associations between other transaction record(s), as described herein.

For example, as shown in FIG. 5, in a scenario in which the purchaser wishes to place another order with the vendor, accounting application 112A executing at device 110A can generate a new purchase order (e.g., for “AA BATTERIES,” which can be the identifier 222A used internally at device 110A). Transaction execution application 114A can process such a selection or request (e.g., in conjunction with transaction coordination engine 142 and/or transaction repository 170). In doing so, transaction execution application 114A and/or transaction coordination engine 142 can determine that device 110B (e.g., the vendor to which the purchase order is directed) utilizes a different identifier to refer to the same item (e.g., “DURACELL AA LITHIUM BATTERIES . . . ”). Such a determination can be computed, for example, based on the association between parameters 122A and 122X as stored in transaction repository 170 (e.g., with respect to transaction records 124A, 124B, which correspond to a prior transaction between the referenced entities).

Upon determining that the vendor to whom the referenced order is directed utilizes a different nomenclature, naming convention, identifier, etc. to refer to the same item, transaction execution application 114A can insert, inject, or otherwise modify or adjust a transaction record 224A to incorporate parameter(s) or other content that are consistent with the recipient's internal operations. For example, as shown in FIG. 5, transaction execution application 114A can generate transaction record 224A to incorporate parameter 222X (e.g., “DURACELL AA LITHIUM BATTERIES . . . ,” reflecting a naming convention utilized by vendor 110B). In doing so, upon receipt of such a transaction record, vendor 110B can process it with little if any ambiguity, confusion, or manual review.

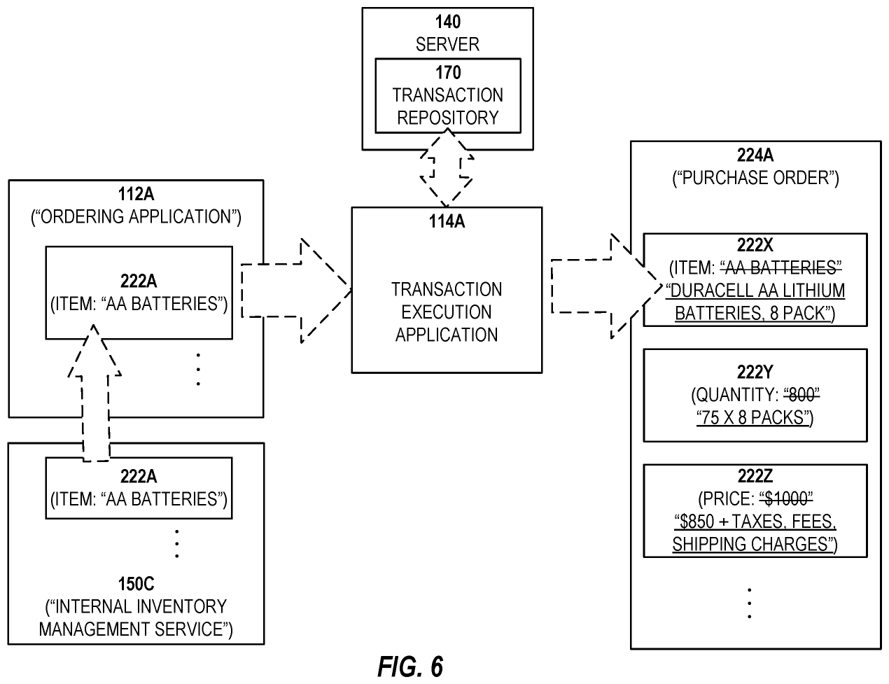

Further aspects of the described features and functionalities are depicted in FIG. 6. As shown in FIG. 6, the referenced purchaser can utilize or maintain a system, service, etc. 150C which is used (e.g., internally) to manage inventory. In such a system, the purchaser can utilize a parameter, identifier, naming convention, etc. 222A to refer to a particular item (e.g., “AA BATTERIES”) as shown in FIG. 6.

As is also shown in FIG. 6, application 112A (e.g., an ordering application) can be configured to operate in conjunction with service 150C. For example, upon determining that inventory for item 222A falls below a defined threshold, application 112A (e.g., an ordering or accounting application) can generate a purchase order to initiate the purchase of more of the referenced item.

Transaction execution application 114A can process a request generated by ordering application 112A. In doing so, transaction execution application 114A can interface or otherwise communicate with server 140 and/or transaction repository 170. For example, transaction execution application 114A can access and/or otherwise analyze prior transaction record(s) corresponding to prior transaction(s) with the referenced vendor. Alternatively, such transaction record(s) can reflect prior transaction(s) between other parties (which can reflect, for example, the manner in which the referenced vendor and/or other vendors may refer internally to the item the purchaser seeks to order).

As noted, in certain implementations the described technologies can determine that the item that the purchaser references using one parameter, identifier, etc. 222A (e.g., “AA BATTERIES,” as used in the purchaser's internal inventory management service 150C and accounting/ordering application 112A) can be identified using another identifier, parameter, etc., by the vendor from whom the purchaser wishes to order (e.g., “DURACELL AA LITHIUM BATTERIES . . . ”). Such a determination can be computed, for example, based on the association between parameters as reflected in prior and/or related transactions (e.g., the association between parameters 122A and 122X as stored in transaction repository 170 and described herein).

Accordingly, upon determining that the order generated by application 112A references a parameter 222A that corresponds to another parameter used by the vendor to whom the order is directed, the described technologies can adjust, modify, or otherwise update aspects of such a transaction record 224A (e.g., a purchase order). As shown in FIG. 6, such adjustments can further conform the transaction record 224A to the nomenclature, naming convention, formatting, etc. used within the internal operations of the entity to which it is directed (e.g., device 110B). For example, as shown in FIG. 6, in lieu of transmitting a purchase order for “AA BATTERIES” (which may be ambiguous or more challenging to process for the vendor), the described technologies can substitute another parameter 222X, which conforms to the nomenclature, naming convention, formatting, etc. used by device 110B (e.g., the vendor). In doing so, the purchaser can continue to utilize its own internal naming conventions (e.g., for “AA BATTERIES” within service inventory service 150C, ordering application 112A, etc.), while the purchase orders transmitted to the vendor include naming conventions, parameters, etc., consistent with the vendor's systems, operations, etc. (e.g., referencing “DURACELL AA LITHIUM BATTERIES . . . ”).

As also shown in FIG. 6, the described technologies can further adjust, modify, or otherwise update other aspects of such a transaction record 224A (e.g., the third transaction record referenced at 10500 such as a purchase order). For example, in certain scenarios a purchaser may wish to purchase a defined quantity of an item, though the vendor does not currently hold such a quantity in stock. By way of illustration, as shown in FIG. 6, though the referenced purchaser may wish to purchase 800 batteries, the vendor may currently have less than the desired quantity in stock. In lieu of the purchaser sending a purchase order for the entire amount desired (e.g., 800), and the purchaser and vendor then needing to manually resolve/reconcile whether and how the order should partially proceed, the described technologies can further integrate aspects of the inventory management system of the vendor. In doing so, orders generated by the purchaser can be consistent with quantities available for delivery by the vendor.

For example, as shown in FIG. 6, though the referenced purchaser may wish to purchase 800 batteries, the vendor may have less than this quantity in stock. Such a determination can be computed, for example, by transaction execution application and/or server 140 (e.g., based on access to real-time inventory of the vendor). Based on such a determination, transaction execution application 114A can adjust or modify an order or request originally input by the purchaser (e.g., for 800 batteries) to reflect the quantity the vendor is able to deliver (e.g., “75×8 PACKS,” as shown in FIG. 6).

It can also be appreciated that other aspects of the referenced transaction record 224A can be further adjusted to conform to the requirements, nomenclature, etc. of the vendor. For example, though the purchaser may specify a total number of items in a purchase order (e.g., based on the manner in which such items are managed internally in the purchaser's own inventory system/service), the vendor may manage or sell such items in groupings of a defined number (e.g., packs of eight). For example, as shown in FIG. 6, though the purchaser may wish to purchase batteries in quantities of 100, the vendor may only sell them in packs of eight. Accordingly, the described technologies can be configured to adjust a transaction record (e.g., purchase order) generated by the purchaser to conform to the manner in which the vendor sells the desired item. For example, the described technologies can notify and/or require the purchaser to adjust the desired quantity to conform to the manner in which the vendor manages/sells the item. As shown in FIG. 6, parameter 222Y (e.g., quantity) within transaction record 224A can be adjusted to conform to the quantities, groupings, etc. in which the vendor manages/sells the item.

Moreover, in certain implementations the manner in which the pricing of an item is computed can be integrated within such a transaction record. In lieu of the purchaser awaiting an invoice to determine the final price to be paid (including taxes, fees, shipping charges, etc.), the described technologies can integrate parameters originating from the vendor's pricing system(s). In doing so, the final price, and/or associated fees or other charges can be computed and integrated within the initial purchase order, as shown in FIG. 6.

Further technical advantages and efficiencies can be realized with respect to implementations of the described technologies throughout a supply chain. For example, the described purchaser of batteries (e.g., associated with device 110A) may purchase such batteries to bundle them with other item(s) the purchaser manufacturers, distributes, sells, etc. For example, the purchaser can bundle two AA batteries with a flashlight the purchaser makes/sells to others. By integrating the described technologies, various efficiencies can be realized with respect to subsequent transactions (e.g., at different points within a supply chain).

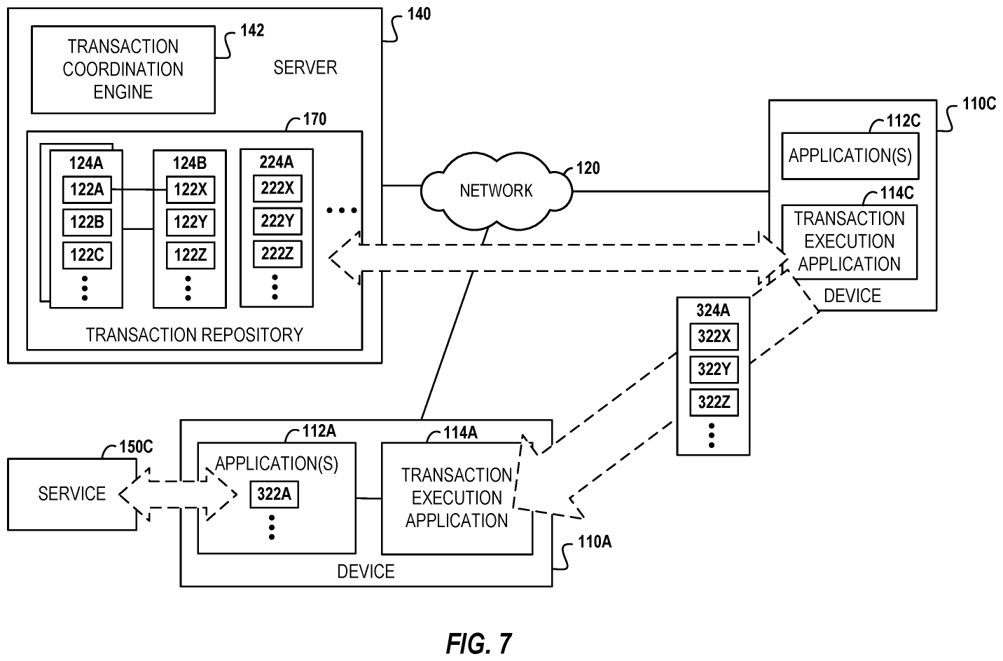

For example, FIG. 7 depicts a scenario in which another purchaser (corresponding to device 110C) wishes to purchase items (e.g., flashlights) from an entity corresponding to device 110A (e.g., the purchaser of the batteries in the scenario(s) described above). As shown in FIG. 7, the entity associated with device 110C can generate and transmit transaction record 324A to the entity associated with device 110A (e.g., the prior purchaser of the batteries). As also shown in FIG. 7, transaction execution application 114C (executing at device 110C) can communicate and/or otherwise coordinate its operations with server 140, transaction coordination engine 142, and/or transaction repository 170. For example, based on prior transaction(s) within the supply chain (as stored in transaction repository 170), the described technologies can adjust aspects of transaction record 324A (e.g., a purchase order originating from device 110C and directed to device 110A).

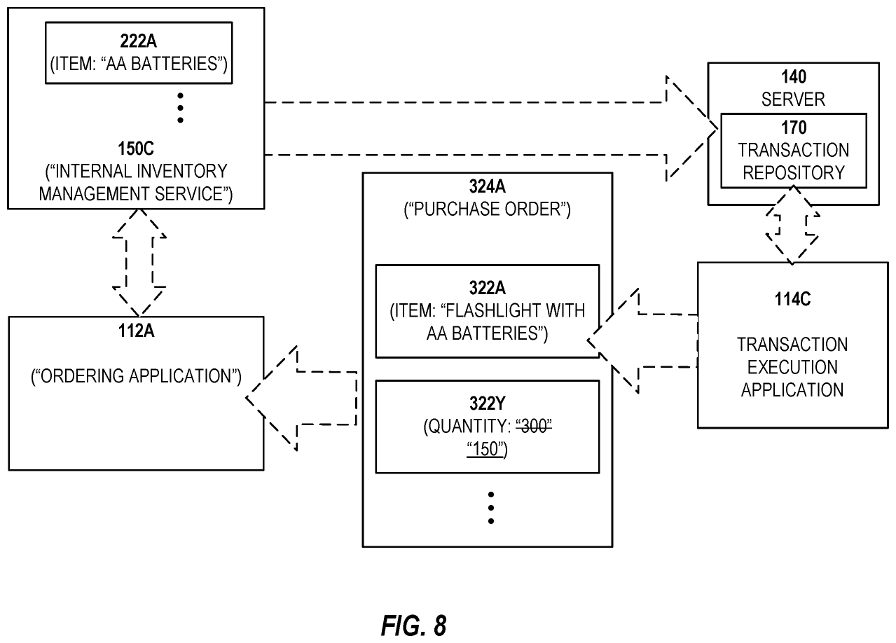

Further aspects of such operations are depicted in FIG. 8. As shown in FIG. 8, transaction execution application 114C (executing at device 110C) can initiate a purchase from the entity associated with device 110A. In doing so, transaction execution application 114C can communicate or otherwise coordinate with server 140, transaction coordination engine 142, and/or transaction repository 170 (e.g., to ensure that the generated order is consistent with the available items and capable of being processed efficiently/automatically upon receipt). As also shown in FIG. 8, service 150C (e.g., an internal inventory service that manages inventory for the entity associated with device 110A) can provide server 140 with access to real-time information regarding the inventory held (e.g., by the entity associated with device 110A). Such information can be used (e.g., by transaction execution application 114C) to adjust or modify an order or request originally input by a purchaser.

For example, as shown in FIG. 8, transaction record 324A reflects that the purchaser associated with device 110C seeks to purchase a flashlight with AA batteries (identifier/parameter 322A). Though purchaser 150C may initially wish to order a quantity of 300 items, based on inputs originating from service 150C, transaction execution application 114C can determine that entity 110A only has 150 items in inventory. Based on such a determination, transaction execution application 114C can adjust transaction record 324A to reflect such availability.

Integrating real-time updates from the referenced internal inventory service(s) 150 can enable additional technical advantages and efficiencies. For example, the described technologies can be further configured to monitor the inventory state of an entity (e.g., a retail store) on an ongoing basis. Doing so can, for example, enable reordering operations to be automated, to ensure an entity is not unexpectedly out of stock for a given item. Doing so can further account for changes along the supply chain (e.g., inventory changes at one or more suppliers).

In one example scenario, the internal inventory management system of a retailer can be configured to communicate with the described technologies on an ongoing basis, to enable automated reordering and other operations. In doing so, rather than manually reordering items on a periodic basis, the described technologies can be configured to automatically initiate reordering operations based on determination(s) that the retailer's inventory reaches a defined threshold. Additionally, in certain implementations various additional rules and conditions can be accounted for in initiating such operation(s). For example, such automated reordering can be further initiated based on market conditions (e.g., to account for desired profit margins, product availability, delivery time, payment terms, and other factors).

By way of further illustration, in certain implementations the described technologies can further account for events, occurrences, or other phenomena (e.g., as occurring at a given location) in initiating the referenced operations/transactions. For example, information originating from external sources (e.g., an event calendar, a sports team's schedule, etc.) can be utilized to automate operations, transactions, etc., such as reordering associated with products demand for which can rise dramatically at intermittent or seasonal intervals or occasions. By way of illustration, it may be advantageous for an entity (e.g., a gas station, convenience store, etc.) located proximate to a sports stadium to have certain inventory on hand at specific times (e.g., memorabilia, souvenirs, etc., related to the team(s) playing at a specific game). Based on determinations computed, for example, based on information originating from various external sources, the described technologies can automate aspects of various operations, transactions, etc. (e.g., automating ordering of event-specific items in advance of a corresponding event), as described herein.

Other phenomena such as weather data, traffic patterns, etc. can also be used to initiate such operations, transactions, etc. For example, when inclement weather (rain, snow, etc.) is forecasted, the described technologies can automate ordering of corresponding items (umbrellas, snow shovels, etc.) that are likely to be in higher demand during such times. In doing so, the described technologies can anticipate such demand increases and automate the ordering or reordering of corresponding items to ensure sufficient stock in advance of such events.

In another example scenario, information concerning other phenomena (e.g., natural disasters such as major storms, hurricanes, etc.) can be utilized to determine what items are likely to be in demand (before, during, and after such an event—e.g., supplies to clean up, secure, and rebuild structures after a major storm). Based on such determinations, automating reordering operations, transactions, etc., can be initiated, as described herein.

The described technologies can also enable other entities across a supply chain (e.g., wholesalers, manufacturers, logistics providers, and other market participants) to anticipate such demand and to automatically initiate operations or other transactions (e.g., manufacturing, shipping, distribution, etc., activities) based on such determinations.

Moreover, as also described herein, other related transaction records and the execution of corresponding payment transaction(s) can be further associated with the underlying transaction record(s) (e.g., purchase orders, invoices, etc.). In doing so, further aspects of the described transactions can be associated with one another, and subsequent operations can be initiated accordingly.

By way of example, identifier(s) utilized by one entity (e.g., the identification of a specific item within a purchase order) can be associated with other identifier(s) utilized by another entity (e.g., the identification of a corresponding item in an invoice, which may utilize different terminology, nomenclature, etc.). Doing so can enable the described technologies to leverage such associations in subsequent operations (e.g., reordering). By way of further example, corresponding financial transactions (e.g., payments sent/received to/from various financial institutions) can be associated with the underlying transactions and the item(s) they correspond to, as described herein.

The described technologies can further enable various technical advantages and efficiencies in scenarios in which item(s) owned by one party are stored and/or offered for sale by another party (e.g., on a consignment basis). In such scenarios, the described technologies can enable underlying reporting, reconciliation, and other associated operations and transactions to be performed automatically and/or in real time.

For example, in a scenario in which a first entity completes a sale of an item on a consignment basis (e.g., on behalf of a second entity), corresponding reporting, payment(s), and other associated operations can be initiated and/or executed automatically, based on the initial underlying transaction (e.g., the purchase of the item by a consumer). Doing so precludes the need for subsequent reconciliation, auditing, payment processing delays, etc. Additionally, initiating such related transactions automatically (e.g., in response to the initial purchase) can further facilitate subsequent operations (e.g., the event of a return). For example, if a consignment purchase is returned (or if it is damaged or lost in transit and is not delivered satisfactorily), the described technologies can automatically reverse such payments and/or initiate other appropriate operations.

By way of further illustration, the described technologies can further implement operations, transactions, etc., initiated based on inputs, notifications, etc., originating from other sources. By way of illustration, various tracking/logistics technologies (e.g., sensors such as GPS, NFC, Bluetooth, etc.) can be integrated to track shipments, delivery status, etc. of an item. Accordingly, upon determining, for example, that a product, shipment, etc., has been successfully delivered to a designated location, accepted by a designated individual, integrated into the inventory of a purchaser (e.g., as reflected within a connected/integrated warehouse or POS system), etc., the described technologies can be further configured to initiate/complete payment or other related operations/transactions, as described herein. Additionally, in certain implementations the described technologies can maintain information originating from such tracking/logistics technologies (e.g., GPS, NFC, other sensors or data sources, etc.) in association with the described transaction record(s) (e.g., within transaction repository 170). Doing so can further enable tracking of inventory along a supply chain (e.g., from a manufacturer to a wholesaler to a retailer to a consumer), and enable further operations based on such association(s), as described here.

In a similar manner, the described technologies can be implemented to enable rebates or other discounts that may be initiated or subsidized by a supplier, manufacturer, etc. For example, in lieu of collecting coupons or other documentation, submitting such information to a manufacturer/rebate provider, and awaiting review and approval (e.g., before rebate funds are disbursed), the described technologies can provide such information at the time of the transaction. For example, upon completion of a transaction involving a rebate, coupon, etc., the described technologies can automatically compile and provide the rebate provider with the underlying transaction information, documentation, etc., and/or can further facilitated automatic disbursement of corresponding promotional funds.

Moreover, in certain implementations the described technologies can be utilized to impose or enforce purchasing limitations in certain scenarios, e.g., with respect to government benefits or subsidies which may be limited to specific products, categories, and/or items that can be purchased from a retailer. For example, certain government benefits may only be utilized on food items, but not on alcohol or other products otherwise sold at supermarkets or other retail establishments. By implementing the described technologies (which associate underlying financial transactions with specific, itemized transaction records), such transactions can be initiated and/or executed with respect to specific line items (e.g., eligible food items), while preventing use on non-qualified items. Similarly, the described technologies can enable retailers that may otherwise not primarily sell food items (e.g., gas stations) to participate in such programs, e.g., by enabling transaction processing with respect to line items that meet required criteria (e.g., food items, etc.). In another example scenario, an entity can issue credit cards, debit cards, etc., to its employees for use at particular establishments (e.g., gas stations) for specific purchase types (e.g., for gas but not other purchases). By incorporating information corresponding to the contents of a purchase within a transaction record, the described technologies can be configured to restrict such purchases to ensure they comply with designated restrictions or other limitations.

At operation 1060, received querie(s) can be processed (e.g., within a decentralized network, such as a network generated based on association(s) between at the referenced first transaction record, second transaction record, and/or third transaction record, as described herein.

By way of further example, implementing the described technologies throughout a supply chain (e.g., as described herein) can enable further technical advantages and efficiencies. For example, implementing the described technologies at multiple points across a supply chain can establish a decentralized network that can facilitate the identification and/or transaction of goods across numerous nodes (each of which can be, for example, a prospective or actual merchant or purchaser of various goods, services, etc.). In doing so, an entity seeking to purchase specific items can initiate a query for such goods, and the described technologies can query the real-time availability of such goods across multiple inventory systems (each of which may identify identical or otherwise corresponding goods in a different way, as described herein).

For example, FIG. 9 depicts a scenario in which a purchaser (corresponding to device 110D) wishes to purchase one or more item(s). In such a scenario, the referenced purchaser may not know (or be capable of identifying) a specific merchant from whom to purchase the item(s). As shown in FIG. 9, the purchaser 110D can generate a transaction record 424A (e.g., a purchase order generated by device 110D). As described above, such a transaction record can include an identification of the item the purchaser wishes to acquire (“AA BATTERIES”), a quantity the user wishes to acquire (“800”) a price the user wishes to pay (“$1000”) and other parameters (e.g., delivery date, delivery location, etc.).

As noted, the referenced purchaser may not know the identity of some (or any) prospective merchants who may currently hold inventory capable of fulfilling the referenced order. For example, certain prospective merchants may utilize different identifiers to refer to aspects of items that may fulfill the referenced order (e.g., “DURACELL AA LITHIUM BATTERIES . . . ,” “100×8 PACKS,” etc.). Additionally, certain prospective merchants may not be capable of (or interested in) fulfilling all potential orders (e.g., orders below a minimum quantity, below a minimum profit margin, etc.).

Accordingly, as described herein, in lieu of directing the referenced transaction record 424A to specific merchant(s), the described technologies can enable the purchaser 110D to direct it to server 140 (which implements the described decentralized inventory network). As described herein, server 140 can maintain transaction repository 170 which stores other transaction record(s), e.g., as associated with one another. The associations between such stored transaction records can enable the identification of other merchants or entities that may hold inventory that corresponds to the item sought by the purchaser. Such stored association(s) between transaction records can also be utilized to identify such inventory even in scenarios in which different entities utilize different identifiers in reference to the same or comparable products.

For example, though transaction record 424A (originating from device 110D) seeks inventory associated with one identifier (e.g., “AA BATTERIES”), the described technologies can leverage associations between multiple transaction records (e.g., as stored in transaction repository 170) to identify inventory of the same or comparable product(s) that may be maintained by other entities under different identifier(s) (e.g., “DURACELL AA LITHIUM BATTERIES . . . ”), as described herein. For example, as shown in FIG. 9, devices 110A, 110B, and 110C can each maintain inventory of items (corresponding to identifiers 422A, 422B, and 422C, respectively) which can be determined (based on associations between transaction records, e.g., as stored in transaction repository 170) to be comparable to transaction identifier 422X (e.g., “AA BATTERIES,” as referenced in purchase order 424A). Based on such determination(s), the described technologies can further query services 150C, 150D, and 150E (corresponding to respective inventory management systems for the referenced entities). Based on such real-time inventory data, the described technologies can further facilitate transaction(s) between the parties, as described herein.

By way of further illustration, the described technologies can leverage transaction records and/or real-time inventory data (reflecting the distribution of relevant inventory at various points across a supply chain) and leverage such data to prevent or resolve supply chain disruptions and other challenges. For example, as described herein (e.g., with respect to FIGS. 7-8), certain points along a supply chain may purchase and hold inventory which can be bundled and further distributed with other items (e.g., batteries which are packaged and sold with flashlights, etc.). While such entitie(s) do not generally sell such inventory (e.g., batteries) as is, in certain scenarios it may be advantageous (for multiple parties) to enable such transactions (e.g., to enable an entity holding such inventory to facilitate a time-sensitive transaction which can be advantageous for multiple parties).

In another example scenario, various unexpected conditions or events can cause disruptions in otherwise reliable supply chains (e.g., natural disasters, political unrest, shipping delays, etc.). In such scenarios, various market participants may unexpectedly find themselves with dwindling inventory of certain items and little or no options to restock such items on a reliable basis. However, as noted above, the described technologies maintain transaction records which reflect the flow or transfer of goods across a supply chain and the current inventory held by such entities. Accordingly, though various market participants (e.g., other retail establishments) may not generally provide such items for sale, the described technologies can provide insight into the availability of such items (e.g., an inventory of the batteries sought by one retailer as held by an electronics dealer who bundles batteries with electronic items when sold).

In such scenario(s), the described technologies can be further configured to initiate various operations to facilitate the distribution of such inventory to account for supply chain disruptions. In one example scenario, the described technologies can preemptively solicit a proposed purchase price from the entity seeking the inventory and can then prompt and/or otherwise propose such a transaction to the entity holding the inventory. In another example scenario, the entity holding the inventory can designate that it is open to initiating transactions in which it can achieve a profit margin above a defined threshold (e.g., more than 20% profit above the price for which the item was purchased). In doing so, the described technologies can effectively implement a decentralized network, through which inventory held across multiple entities can be leveraged and distributed in scenarios that can be advantageous for multiple parties.

The described technologies can also be advantageously implemented in a manner that enables multiple participants across an industry supply chain to anticipate inventory shortages and/or to ensure that merchants and other actors have access to necessary inventory, including under changing and/or unusual market conditions. Such functionality (and other related operations) can be enabled based on underlying associations between transaction records that are generated and maintained by the described technologies. In doing so, unexpected delays, cost increases, and other potential disruptions within a supply chain can be identified, anticipated, and/or preempted, as described herein.

For example, in a scenario in which a manufacturing shortage arises, a merchant who reorders in advance within a time interval that is frequently sufficient for restocking (e.g., 30 days) may be unexpectedly out of stock if manufacturing shortages or shipping delays occasionally create circumstances under which the merchant cannot obtain the items sought (e.g., until 60 days later). In such scenarios, the described technologies can identify and/or predict such delays (e.g., based on inventory state(s) and/or orders from multiple entities along the supply chain, including those which may be several degrees removed from the vendor). In doing so, the described technologies can preemptively prompt the merchant to reorder the product in advance of their normal ordering practice, and/or initiate other corrective action, as described herein.

It should also be understood that, in certain implementations, various aspects of the operations described herein with respect to a single machine (e.g., server 140) can be implemented with respect to multiple machines. For example, in certain implementations identifier repository 160 and transaction repository 170 can be implemented as independent servers, machines, services, etc.

It can also be appreciated that the described technologies provide numerous technical advantages and improvements over existing technologies. For example, the described technologies can enable and automate the secure and verifiable execution of the referenced transactions and/or other operations using existing accounts, services, institutions, transaction frameworks/protocols, etc., while also providing enhanced functionality, security, and efficiency, as described herein.

It can therefore be appreciated that the described technologies are directed to and address specific technical challenges and longstanding deficiencies in multiple technical areas, including but not limited to transaction authentication, transaction processing, and secure operations. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

It should be understood that the examples provided herein are intended only for purposes of illustration and any number of other implementations are also contemplated. Additionally, the referenced examples (including the described rules and/or other techniques) can be combined in any number of ways.

It should also be noted that while the technologies described herein are illustrated primarily with respect to secure transaction networks, the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-10 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 11 is a block diagram illustrating components of a machine 1100, according to some example implementations, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein can be executed. The instructions 1116 transform the non-programmed machine into a particular machine programmed to carry out the described and illustrated functions in the manner described. In alternative implementations, the machine 1100 operates as a standalone device or can be coupled (e.g., networked) to other machines. In a networked deployment, the machine 1100 can operate in the capacity of a server machine or a client machine in a server-client network environment, or as a peer machine in a peer-to-peer (or distributed) network environment. The machine 1100 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 can include processors 1110, memory/storage 1130, and I/O components 1150, which can be configured to communicate with each other such as via a bus 1102. In an example implementation, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1112 and a processor 1114 that can execute the instructions 1116. The term “processor” is intended to include multi-core processors that can comprise two or more independent processors (sometimes referred to as “cores”) that can execute instructions contemporaneously. Although FIG. 11 shows multiple processors 1110, the machine 1100 can include a single processor with a single core, a single processor with multiple cores (e.g., a multi-core processor), multiple processors with a single core, multiple processors with multiples cores, or any combination thereof.

The memory/storage 1130 can include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, “machine-readable medium” means a device able to store instructions (e.g., instructions 1116) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine (e.g., processors 1110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion and the grouping is in no way limiting. In various example implementations, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1150 can include biometric components 1156, motion components 1158, environmental components 1160, or position components 1162, among a wide array of other components. For example, the biometric components 1156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., accelerometer), gravitation sensor components, rotation sensor components (e.g., gyroscope), and so forth. The environmental components 1160 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1162 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1150 can include communication components 1164 operable to couple the machine 1100 to a network 1180 or devices 1170 via a coupling 1182 and a coupling 1172, respectively. For example, the communication components 1164 can include a network interface component or other suitable device to interface with the network 1180. In further examples, the communication components 1164 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 can be another machine or any of a wide variety of peripheral devices (e.g., a peripheral device coupled via a USB).

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1164, such as location via Internet Protocol (IP) geolocation, location via Wi-Fi® signal triangulation, location via detecting an NFC beacon signal that can indicate a particular location, and so forth.

In various example implementations, one or more portions of the network 1180 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 can include a wireless or cellular network and the coupling 1182 can be a Code Division Multiple Access (CDMA) connection, a Global System for Mobile communications (GSM) connection, or another type of cellular or wireless coupling. In this example, the coupling 1182 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 11G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 can be transmitted or received using a transmission medium via the coupling 1172 (e.g., a peer-to-peer coupling) to the devices 1170. The term “transmission medium” shall be taken to include any intangible medium that is capable of storing, encoding, or carrying the instructions 1116 for execution by the machine 1100, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

1. A system comprising:
a processing device; and
a memory coupled to the processing device and storing instructions that, when executed by the processing device, cause the system to perform operations comprising:
receiving a first transaction record comprising one or more first parameters, wherein the first transaction record is generated by a first entity and directed to a second entity;
processing the first transaction record to determine whether at least one of the one or more first parameters are consistent with one or more parameters utilized by the second entity;
generating, based on the processing, a second transaction record comprising one or more second parameters that correspond to at least one of the one or more first parameters; and
initiating one or more operations with respect to the second transaction record.

2. (canceled)

3. The system of claim 1, wherein the one or more second parameters are associated with the one or more first parameters based on one or more semantic similarities.

4. (canceled)

5. The system of claim 1, wherein the one or more second parameters are associated with one or more third parameters that are associated with one or more entities not associated with the first transaction record or the second transaction record.

6. (canceled)

7. The system of claim 1, wherein initiating one or more operations comprises initiating a secure transaction based on the second transaction record, and wherein the secure transaction comprises a transaction with respect to at least one of the first entity or the second entity associated with the first transaction record or the second transaction record.

8. The system of claim 1, wherein initiating one or more operations comprises validating a transaction.

9. The system of claim 1, wherein initiating one or more operations comprises generating an associated transaction validation.

10. The system of claim 1, wherein initiating one or more operations comprises selecting a transaction execution account.

11. The system of claim 1, wherein initiating one or more operations comprises initiating the one or more operations based on one or more sensor inputs.

12. The system of claim 1, further comprising generating a third transaction record.

13. The system of claim 12, wherein generating a third transaction record comprises generating the third transaction record based on one or more associations between the first transaction record and the second transaction record.

14. The system of claim 12, wherein generating a third transaction comprises injecting at least one of the one or more first parameters into the second transaction record.

15. The system of claim 12, wherein generating a third transaction record comprises generating the third transaction record based on one or more inventory determinations.

16. The system of claim 12, wherein generating a third transaction record comprises adjusting the third transaction record.

17. The system of claim 12, wherein generating a third transaction record comprises adjusting the third transaction record based on one or more inventory determinations.

18. The system of claim 12, wherein generating a third transaction record comprises generating the third transaction record based on one or more determinations, and wherein the one or more determinations are computed based on one or more sensor inputs.

19. (canceled)

20. (canceled)

21. The system of claim 12, wherein generating a third transaction record further comprises reconciling one or more aspects of the third transaction record based on one or more sensor inputs.

22. The system of claim 12, further comprising:
receiving a query; and
processing the query within a decentralized network based on one or more associations between at least one of the first transaction record, second transaction record, or the third transaction record.

23. A method comprising:
receiving a first transaction record comprising one or more first parameters, wherein the first transaction record is generated by a first entity and directed to a second entity;
processing the first transaction record to determine whether at least one of the one or more first parameters are consistent with one or more parameters utilized by the second entity;
generating, based on the processing, a second transaction record comprising one or more second parameters that correspond to at least one of the one or more first parameters;
initiating one or more operations with respect to the second transaction record; and
generating a third transaction record based on one or more associations between the first transaction record and the second transaction record and one or more determinations computed based on one or more sensor inputs.

24. The method of claim 23, further comprising:
receiving a query; and
processing the query within a decentralized network based on one or more associations between at least one of the first transaction record, second transaction record, or the third transaction record.

25. A non-transitory computer readable medium having instructions stored thereon that, when executed by a processing device, cause the processing device to perform one or more operations comprising:
receiving a first transaction record comprising one or more first parameters, wherein the first transaction record is generated by a first entity and directed to a second entity;
processing the first transaction record to determine whether at least one of the one or more first parameters are consistent with one or more parameters utilized by the second entity;
generating, based on the processing, a second transaction record comprising one or more second parameters that correspond to at least one of the one or more first parameters;
initiating a secure transaction respect to the second transaction record and at least one of the first entity or the second entity;
generating a third transaction record based on (a) one or more associations between the first transaction record and the second transaction record and (b) one or more determinations computed based on one or more sensor inputs; and
processing a query within a decentralized network based on one or more associations between at the first transaction record, the second transaction record, and the third transaction record.
